(19) United States
(12) Patent Application Publication
(10) Pub. No.: US 2003/0149625 A1
(43) Pub. Date: Aug. 7, 2003

(54) Method of providing a dividend on a transaction based on calculating and providing a third-party discount

(76) Inventors: Ricci J. Leonardi, Gurnee, IL (US); John F. Mangham, Grayslake, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/310,753

(22) Filed: Dec. 5, 2002

Related U.S. Application Data
(60) Provisional application No. 60/355,554, filed on Feb. 6, 2002.

(51) Int. Cl. G06F 17/60

(52) U.S. Cl. 705/14; 705/21

(57) ABSTRACT

A method of linking a plurality of third-party discounters to a unique customer ID in a retail sales transaction that comprises assigning a unique customer ID to a customer, creating a customer account record that is associated with the unique customer ID, and adding a plurality of registered third-party discounters to the customer account record. The method also includes processing a sale of a good in a sales transaction, identifying a registered third-party discounter associated with the good, and verifying that the customer is currently registered with the registered third-party discounter associated with the good to ensure a current eligibility of the customer. The method further includes applying a predetermined third-party discount to a gross sales price of the good to determine a net sales price for the good, and collecting a monetary value from the customer equaling the net sales price for the good.

### CROSS-REFERENCE TO RELATED APPLICATIONS

This application claims priority to U.S. Provisional Application Serial No. 60/355,554, entitled “Method of Providing a Dividend On a Transaction Based On Calculating and Providing a Third-Party Discount,” filed Feb. 6, 2002 (Attorney Docket No. 29488/38208), the disclosure of which is hereby expressly incorporated herein by reference.

### TECHNICAL FIELD

The present patent relates generally to techniques for providing third-party discounts and awarding dividends based on a net-transaction amount.

### BACKGROUND

Incentive award programs are designed to drive a desired behavior for customers, participants, employees, etc. The incentive award programs may offer as awards, for example, cash, dividends, points, prizes, and even some intangible items.

In a separate scenario, some organizations have offered their clients participation in systems that are capable of providing discounts on goods or services from third parties, and in some situations, the organizations' systems may have limited abilities to aggregate discounts from multiple third parties on goods or services purchased by a consumer. One example of these systems is commonly found in the restaurant industry, where an organization provides its participants discounts to a plurality of participating restaurants.

### BRIEF DESCRIPTION OF THE DRAWINGS

FIG. 1 is a block diagram of an embodiment of an intelligent network system.

FIG. 2 is a block diagram of an alternative embodiment of an intelligent network system that includes a separate dividend manager.

FIG. 3 is a block diagram of an alternative embodiment of an intelligent network system that includes a client device.

FIG. 4 is a schematic diagram of some of the components of the network computer shown in FIGS. 1, 2, and 3.

FIG. 5 is a schematic diagram of an embodiment of one of the facilities shown schematically in FIGS. 1, 2, and 3.

FIGS. 6A and 6B are two parts of a flowchart showing some of the steps used in providing a dividend to a customer based on a transaction that includes calculating a net amount based on a third-party discount.

FIGS. 7A, 7B, and 7C are three parts of a flowchart showing some of the steps used in an alternative embodiment to the embodiment shown in FIGS. 6A and 6B.

### DETAILED DESCRIPTION OF VARIOUS EMBODIMENTS

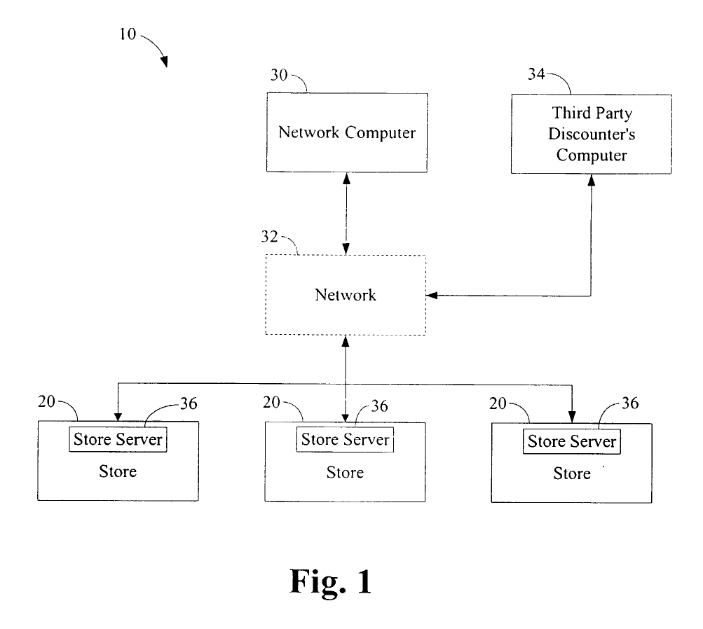

FIG. 1 illustrates an embodiment of a data network 10. Referring to FIG. 1, the data network 10 may include a first group of stores or facilities 20 operatively coupled to a network computer 30 via a network 32. The plurality of stores 20 may be located, by way of example rather than limitation, in separate geographic locations from each other, in different areas of the same city, or in different states. The network computer 30 may be connected to a third-party discounter's computer 34 via the network 32. The third-party discounter may be a manufacturer of a product or any other organization providing a discount on a product or a service. The network 32 may be provided using a wide variety of techniques well known to those skilled in the art for the transfer of electronic data. For example, the network 32 may comprise dedicated access lines, plain, ordinary telephone lines, satellite links, combinations of these, etc. Additionally, the network 32 may include a plurality of network computers or server computers (not shown), each of which may be operatively interconnected in a known manner. Where the network 32 comprises the Internet, data communication may take place over the network 32 via an Internet communication protocol.

The network computer 30 may be a server computer of the type commonly employed in networking solutions. The network computer 30 may be used to accumulate, analyze, and download data relating to the operation of the stores 20 and more particularly to third-party discounts associated with customers' accounts as well as dividend balances associated with the customers' accounts. For example, the network computer 30 may periodically receive data from each of the stores 20 indicative of registered discounts available to a customer from a third-party discounter. This information may be added to the customer's account to assist in determining a net amount to charge the customer for a given transaction. The network computer 30 may also receive information related to a dividend given to the customer for purchasing the goods in the transaction. This information may be accumulated and periodically transferred to the third-party discounter 34 via the network 32. The stores 20 may include one or more store servers 36 that may be utilized to store customer account information that includes discounts available to the customer from one or more third-party discounters.

Although the data network 10 is shown to include one network computer 30, one third-party discounter 34, and three stores 20, it should be understood that different numbers of computers and stores may be utilized. For example, the network 32 may include a plurality of network computers 30, a plurality of third-party discounters 34, and hundreds or thousands of stores 20, all of which may be interconnected via the network 32. According to the disclosed example, this configuration may provide several advantages, such as, for example, enabling near real time uploads and downloads of information as well as periodic uploads and downloads of information. This provides for a primary backup of all the information generated in transactions where products are sold, discounts are calculated and given, and dividends are applied.

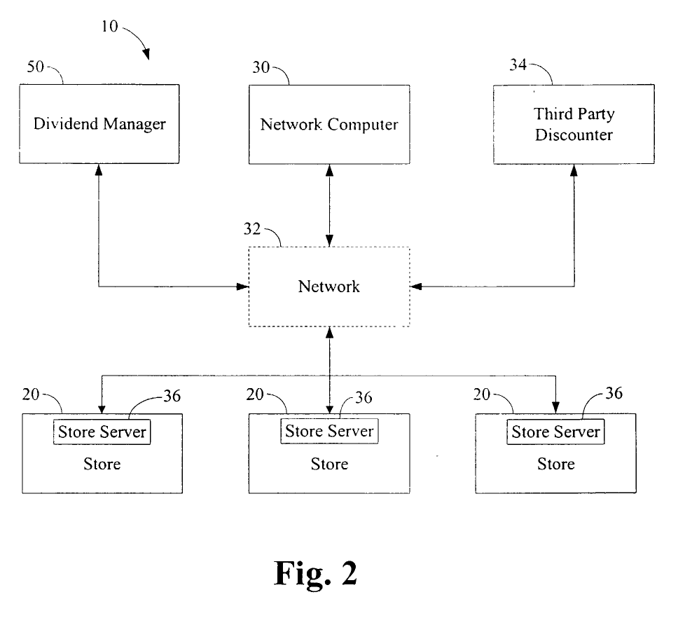

FIG. 2 illustrates an alternative embodiment of the network 10 shown in FIG. 1, wherein a dividend manager 50 is used to manage the dividends awarded to customers. The embodiment of FIG. 2 is similar to the embodiment shown in FIG. 1 and includes many of the same structures and components. For clarity, the structures and components remaining the same are shown with like reference numbers as those from FIG. 1. Referring to FIG. 2, the dividend manager 50 may be linked to the network 32 so that data may be transferred between the dividend manager 50 and the network computer 30, the stores 20 and the third-party discounter 34.

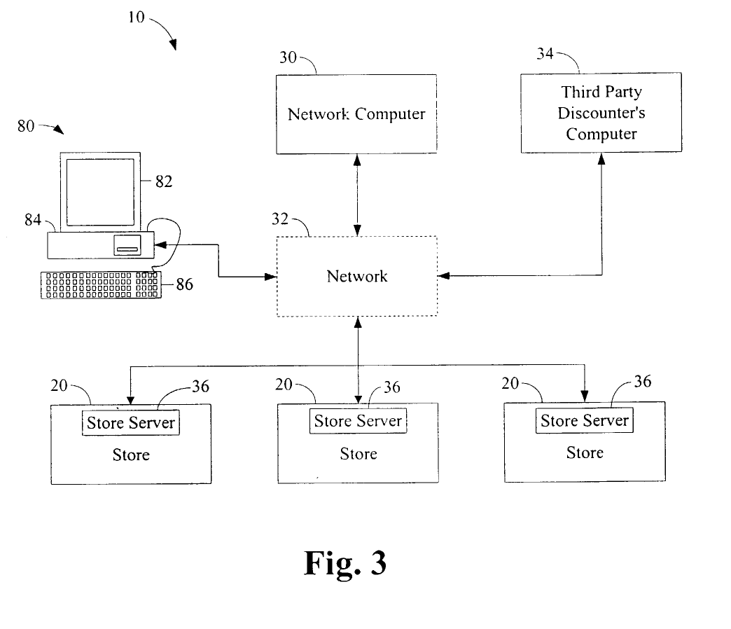

The dividend manager 50 may be used as a repository to store dividend account balances for customers. In addition to storing customers' dividend account balances, the dividend manager 50 may also be used to calculate the appropriate dividend to give to a customer for a specific transaction. The dividend manager 50 may be an unrelated third party, or it may be a subsidiary or division of the retailer. FIG. 3 illustrates an alternative embodiment of the network 10 shown in FIG. 1, wherein a client device 80 is linked to the network 32 to enable a customer to order goods from a retailer using the client device 80. The embodiment of FIG. 3 is similar to the embodiment shown in FIGS. 1 and 2 and includes many of the same structures and components. For clarity, the structures and components remaining the same are shown with like reference numbers as those from FIGS. 1 and 2.

Referring to FIG. 3, the client device 80 may include a display 82, a controller 84, a keyboard 86, as well as a variety of other input/output devices. The client device 80 may be linked to the network 32 so that a customer may order goods from the retailer without having to physically visit one of the stores 20 to purchase the customer's goods. Further, the customer may still receive discounts from third-party discounters such as the third-party discounter 34 and a dividend from the retailer, even though the customer purchased the goods from the client device 80. The retailer may provide the customer the option of having the ordered goods shipped to the customer or having the ordered goods made available at a local retail store 20 for pickup by the customer.

While the network 10 is shown to include one network computer 30, one third-party discounter 34, three stores 20, and one client device 80, it should be understood that different numbers of computers, stores, and client devices may be utilized. For example, the network 32 may include a plurality of network computers 30, a plurality of third-party discounters 34, hundreds or thousands of stores 20, and a plurality of client devices 80, all of which may be interconnected via the network 32.

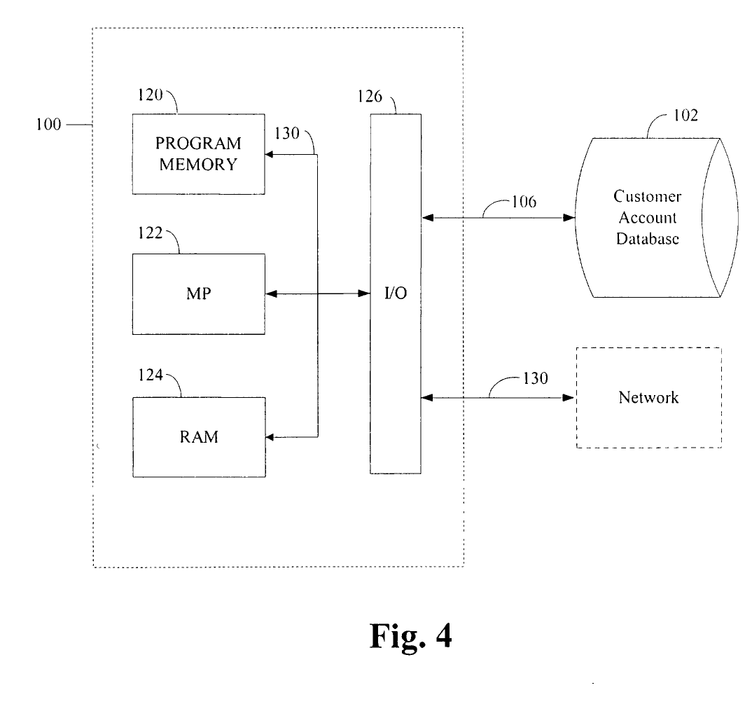

FIG. 4 is a schematic diagram of one possible embodiment of the network computer 30 shown in FIGS. 1, 2, and 3. The network computer 30 may have a controller 100 that is operatively connected to a customer account database 102 via a link 106. It should be noted that, while not shown, additional databases may be linked to the controller 100 in a known manner.

The controller 100 may include a program memory 120, a microcontroller or a microprocessor (MP) 122, a random-access memory (RAM) 124, and an input/output (I/O) circuit 126, all of which may be interconnected via an address/data bus 130. It should be appreciated that although only one microprocessor 122 is shown, the controller 100 may include multiple microprocessors 122. Similarly, the memory of the controller 100 may include multiple RAMs 124 and multiple program memories 120. Although the I/O circuit 126 is shown as a single block, it should be appreciated that the I/O circuit 126 may include a number of different types of I/O circuits. The RAM(s) 124 and programs memories 120 may be implemented as semiconductor memories, magnetically readable memories, and/or optically readable memories, for example. The controller 100 may also be operatively connected to the network 32 via a link 130.

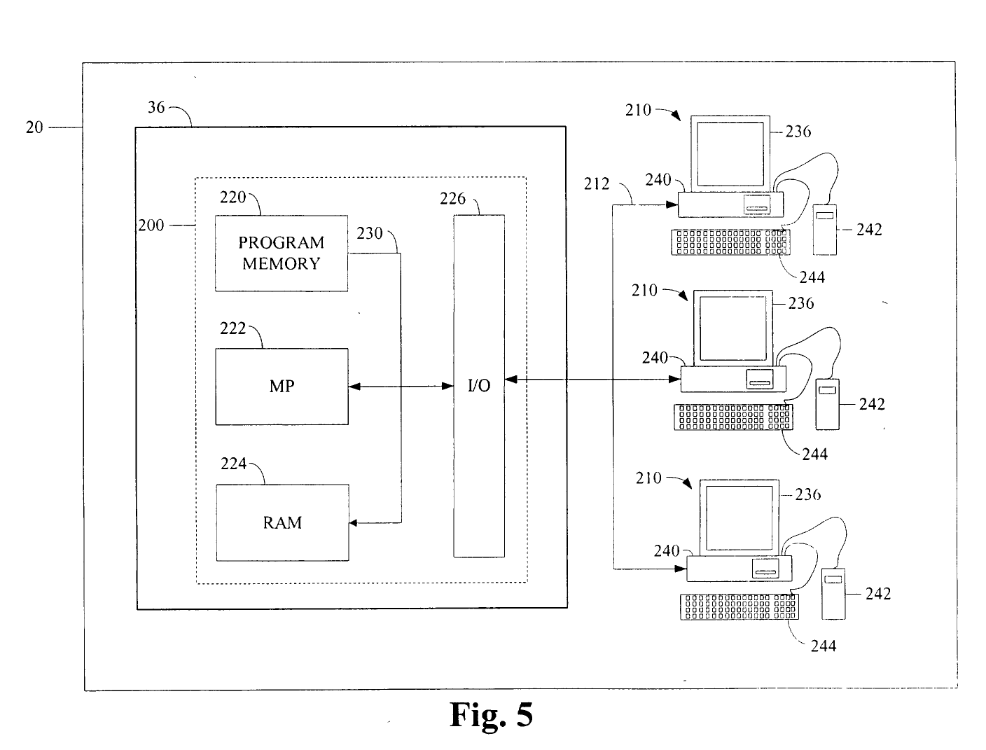

FIG. 5 is a schematic diagram of one possible embodiment of several components located in one or more of the stores 20 from FIGS. 1, 2, and 3. Although the following description addresses the design of the stores 20, it should be understood that the design of one or more of the stores 20 may be different than the design of other stores 20. Also, each store 20 may have various different structures and methods of operation. It should also be understood that the embodiment shown in FIG. 5 illustrates some of the components and data connections present in a pharmacy section of a retail store, however it does not illustrate all of the data connections present in a typical store (i.e., a photo department, a cosmetic department, a plurality of front line terminals, etc.). For exemplary purposes, various designs of the stores are described below, but it should be understood that numerous other designs may be utilized.

The store 20 may have a store server 36, which includes a controller 200, wherein the store server 36 is operatively connected to a plurality of point-of-sale (POS) terminals 210 via a network 212. The network 212 may be a wide area network (WAN), a local area network (LAN), or any other type of network readily known to those persons skilled in the art. The POS terminals 210 may also be operatively connected to the network computer 30 from FIGS. 1-3 via the network 32.

Similar to the controller 100 from FIG. 4, the controller 200 may include a program memory 220, a microcontroller or a microprocessor (MP) 222, a random-access memory (RAM) 224, and an input/output (I/O) circuit 226, all of which may be interconnected via an address/data bus 230. As discussed with reference to the controller 100, it should be appreciated that although only one microprocessor 222 is shown, the controller 200 may include multiple microprocessors 222. Similarly, the memory of the controller 200 may include multiple RAMs 224 and multiple programs memories 220. Although the I/O circuit 226 is shown as a single block, the I/O circuit 226 may include a number of different types of I/O circuits. The RAM(s) 224 and programs memories 220 may also be implemented as semiconductor memories, magnetically readable memories, and/or optically readable memories, for example.

The POS terminals 210 may include a display 236, a controller 240, a printer 242, a keyboard 244, as well as a variety of other input/output devices such as a mouse, touch screen, track pad, track ball, isopoint, voice recognition system, etc. Each POS terminal 210 may be signed onto and occupied by a store employee to assist them in performing their duties. Store employees may sign onto a POS terminal 210 using any generically available technique, such as entering a user name and password. If a store employee is required to sign onto a POS terminal 210, this information may be passed via the link 212 to the store server 36, so that the controller 200 will be able to identify which store employees are signed onto the system and which POS terminal 210 the employees are signed onto. This may be useful in monitoring the store employees' sales performance.

Typically, store servers 36 store a plurality of files, programs, and other data for use by the POS terminals 210 and the network computer 30. One store server 36 may handle requests for subscription data from a large number of POS terminals 210. Accordingly, each store server 36 may typically comprise a high end computer with a large storage capacity, one or more fast microprocessors, and one or more high speed network connections. Conversely, relative to a typical store server 36, each POS terminal 210 may typically include less storage capacity, a single microprocessor, and a single network connection.

### OVERALL OPERATION OF THE SYSTEM

One manner in which an exemplary system may operate is described below in connection with a number of flow charts which represent a number of portions or routines of one or more computer programs. These computer program portions may be stored in one or more of the memories in the controllers 100 and 200, and may be written at any high level language such as C, C++, or the like, or any low-level assembly or machine language. By storing the computer program portions therein, various portions of the memories are physically and/or structurally configured in accordance with the computer program instructions.

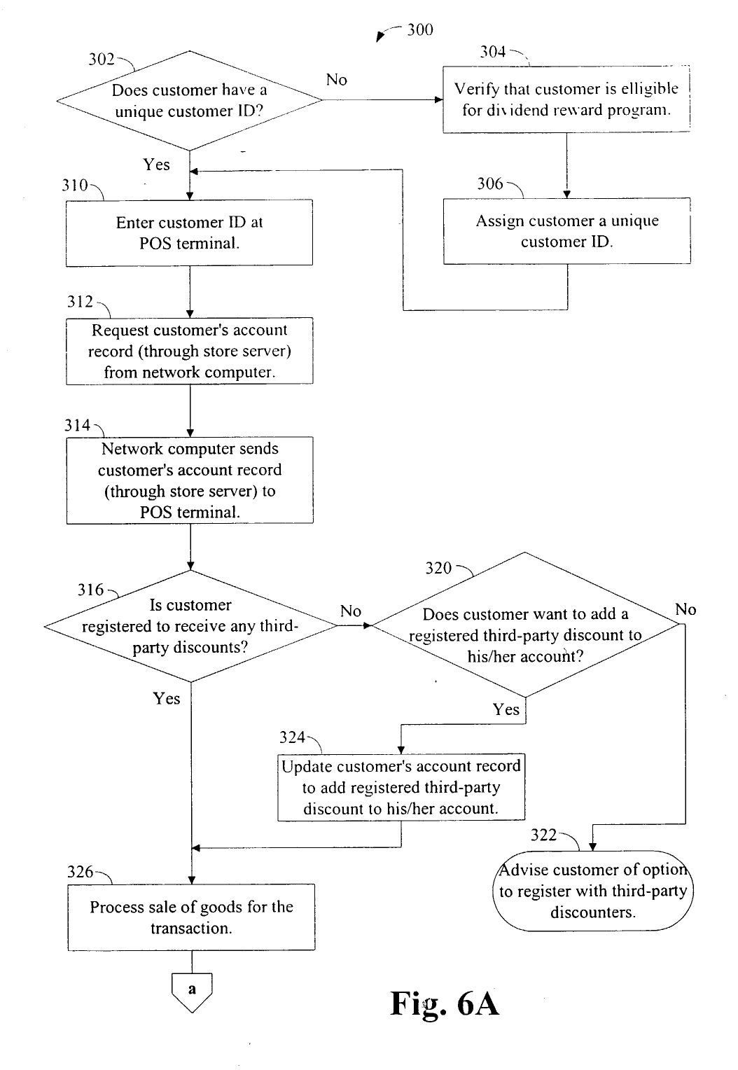

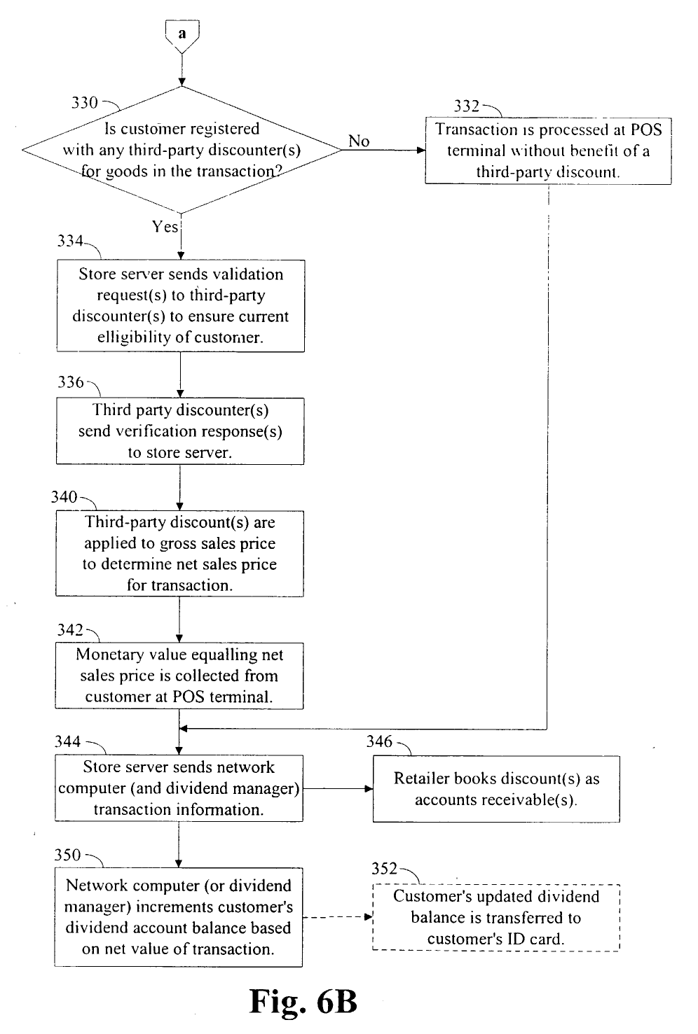

FIGS. 6A and 6B are two parts of a flow chart 300 describing some of the steps used to facilitate verification of customers' discounts as well as managing a dividend reward program. Some of the steps shown in the flowchart 300 may be stored in the memory of the controllers 100 and 200.

Referring to FIG. 6A, the flowchart 300 may begin at a block 302 when a customer presents or orders one or more products for purchase, and a retail store employee performs an inquiry to determine if the customer has a unique customer ID. The unique customer ID may have a plurality of alpha characters, numeric characters, or a combination of alpha numeric characters. For example, the unique customer ID may be a unique sixteen digit number that is assigned to the customer by the retailer.

The unique customer ID may be stored in the retailer's customer account database 102 that is operatively connected to the network computer 30 (See FIG. 4). The unique customer ID may be associated with a large amount of personal information relating to the customer. For example, the customer account database 102 may store information on the customer's name, address, telephone number, birth date, social security number, insurance providers, and other organizations that the customer has previously established a relationship with wherein the organization has agreed to provide the customer with discounts, such as rebates, for example, on the purchase of certain goods (third-party discounters), etc. The customer's personal information may be linked to the customer's unique customer ID and stored in the customer account database 102 using methods well known to those skilled in the art.

The retailer may provide the customer an ID card that includes the unique sixteen digit number, after the unique sixteen digit number is assigned to the customer. As used herein, the term “ID card” is intended to include all types of portable storage devices, such as cards, certificates, and other documents capable of storing or denoting a credit value. This definition includes conventional credit card style ID cards, on which information may be stored, gift cards, phone cards, and smart cards, which may store, process, and update information, among other storage media.

In the current embodiment, the ID card may be provided in a form similar to that of a conventional credit card. Accordingly, the ID card may be a generally rectangular, plastic substrate with a magnetic strip for storing information. It will be appreciated that the precise shape of, and materials used for the ID card is not critical and, in fact, any type of portable storage device may be used. For example, the ID card may be in the form of a key chain card having a storage means affixed thereto.

While the retailer may issue the ID card to the customer, the customer may not be required to present the ID card to a store employee in order to obtain access to the customer's account. The retailer may be able to access the customer's account from the customer account database 102 by obtaining other personal information from the customer, such as, for example, the customer's name, social security number, telephone number, etc. In other words, the retailer may be able to access the customer's account by searching fields other than the field for the unique customer ID in the customer account data base 102. The request may be accomplished by sending a query from the POS terminal 210, through the store server 36 and network 32, to the network computer 30. The network computer 30 may then send a response to the query, back through the network 32 and the storage server 36, to the POS terminal 210.

Still referring to FIG. 6A, if it is determined at the block 302 that the customer does not have a unique customer ID, then the retail employee may verify that the customer is eligible for the dividend reward program at a block 304. The retailer may determine the eligibility requirements for the dividend reward program, and those requirements may be, for example, as simple as determining the age of the customer. If the retail employee determines that the customer meets the retailer's eligibility requirements for the dividend reward program, the retail employee may request the network computer 30 to assign a unique customer ID for the customer at a block 306. The retail employee may alternatively assign a pre-generated unique customer ID to the customer using the POS terminal 210. For example, the store 20 may have a plurality of customer ID cards that have been pre-printed with unique ID numbers. The store employee may select one of the pre-printed ID cards and assign the ID card's unique ID number to the customer.

Once it is determined that the customer has a unique customer ID, then the store employee may enter the unique customer ID at the POS terminal 210, as shown at a block 310. The store employee may then request the customer's account record by initiating a query of the network computer 30 at a block 312. The query initiated at the POS terminal 210 may be transmitted through the store server 36 and the network 32 to the network computer 30. The network computer 30 may cause the controller 100 to perform a search of the customer account database 102 for the customer's unique customer ID. If the customer's account is located, the network computer 30 may send the customer's account record back across the network 32 to the store server 36 and on to the POS terminal 210, as shown at a block 314.

Once the network computer 30 transfers the customer's account record to the store 20, the store server 36 may temporarily store the customer's account record so that retrieval of information or updates to the account record in the near future may be performed locally, thus reducing network traffic. If the customer's account record is not located in the customer account database 102, then the store employee may be prompted to notify the customer accordingly, and ask the customer if they would like to create a new customer account record.

At a block 316, a check may be made to see if the customer is registered to receive any third-party discounts. The customer may receive a third-party discount from a third-party discounter when the customer has previously registered with the third-party discounter to establish a relationship and insure that the customer meets the eligibility requirements of the third-party discounter in order to receive discounts on participating goods from the third-party discounter. After the customer's account record is retrieved from the customer account database 102 and it is determined at the block 316 that the customer is not registered to receive any third-party discounts, then the store employee may be prompted at a block 320 to ask the customer if he/she wants to add a registered third-party discount to his/her account. It should be noted that the customer may be allowed to add third-party discounts to their account record when the customer has previously registered with the third-party discounter. In other words, the customer must have met the eligibility requirements and completed the necessary registration application for each of the third-party discounters that the customer wishes to add to his/her customer account record.

If it is determined at the block 316 that the customer is not registered to receive any third-party discounts and it is further determined at the block 320 that the customer does not want to add a registered third-party discount to his/her account, then the store employee may advise the customer of the option to register with third-party discounters at a block 322, and continue with the transaction without applying a third-party discount. If it is determined at the block 320 that the customer wants to add a registered third-party discount to his/her account, the customer's account record may be updated to add a registered third-party discount to the customer's account at a block 324.

The retailer may give the customer the option to update the customer's account record by electronically accessing the retailer's website. Access to the retailer's web-site may be made available via the Internet, where a customer may enter his/her unique customer ID to access his/her account record where additional affiliations with third-party discounters may be added. The customer may access the internet using the client device 80 from FIG. 3, and the retailer's web-site may be stored on the network computer 30 or any other acceptable server that is connected to the network 32. Alternatively, the customer may be given a mail-in account update form so that the customer may complete the mail-in form and send it to the retailer to perform an update of his/her account.

The store employee may update the customer's account record at the POS terminal 210 by entering a minimal amount of information, such as, for example, the name of the third-party discounter as well as a unique identifier, such as, for example, a plan ID number, that associates the customer with the third-party discounter. The added third-party discount information associated with the customer may be stored in the network computer's customer account database 102.

The third-party discounter and all subsequent third-party discounts may be linked to the single unique customer ID. This continues to remain true when multiple third-party discounters are added to the customer's account record so that a plurality of third-party discounts may be linked to the single unique customer ID. This will allow the customer to give the retail employee the customer's single unique customer ID and obtain the benefit of receiving discounts from multiple third-party discounters on a given transaction. At the time of adding a registered third-party discount to the customer's account, the retailer may verify with the third-party discounter that the customer is registered under the third-party discounter's discount plan. The verification may be sent from the store server 36 through the network 32 to the third-party discounter 34, and the response to the verification may follow a reverse path through the network 32 and the store server 36.

After it is determined that the customer is registered to receive at least one third-party discount from a third-party discounter, the retail employee may process the sale of goods for the transaction at a block 326. The goods may be processed, for example, by scanning a bar code located on the goods or on the packaging for the goods with the use of a scanner or other input device operatively connected to the controller 240 of the POS terminal 210, by manually entering the stock keeping unit (SKU) for the good on the keyboard 244 operatively connected to the controller 240, or any other method well known to those skilled in the art,

FIG. 6B is the second half of the flowchart 300 from FIG. 6A. The flow chart 300 continues at a block 330 where a check is made to determine if the customer is registered with any third-party discounter(s) for goods in the transaction. The check performed at the block 330 is included because there would not be a need to check for any third-party discounts if the goods in the transaction are not goods that the customer is registered to receive discounts on. Therefore, if the goods in the transactions selected by the customer are not affiliated with any third-party discounters, then the transaction is processed at the POS terminal 210 without the benefit of any third-party discounts at the block 332.

If the customer is registered with a third-party discounter to receive a discount on at least one item in the transaction, then the store server 36 may send a validation request through the network 32 to the third-party discounter 34 to insure the current eligibility of the customer, as shown at a block 334. If the customer is currently registered (i.e., eligible and in good standing) with the third-party discounter 34, then the third-party discounter 34 may send a verification response through the network 32 to the store 36 indicating in a real-time fashion that the customer is registered to receive a discount on at least one of the items in the transaction. This is shown at a block 336. If the customer is not currently registered with the third-party discounter, then the third-party discounter 34 may send a negative verification response through the network 32 to the store server 36 wherein the customer may be denied a discount on the good(s). The steps of sending the validation request and response may be repeated if goods in the transaction are eligible for discounts from more than one third-party discounter. In other words, the store server 36 may be capable of performing multiple verifications with multiple third-party discounters when the customers account record is linked to multiple third-party discounters, and goods are present in the transaction that are eligible to receive discounts from the multiple third-party discounters.

Once the retailer receives verification for the third-party discounts, the store server 36 may apply the third-party discount(s) to the gross sales price for the transaction to determine the net sales price for the transaction, at a block 340. The net sales price is the amount the customer is required pay the retailer, and this amount is collected by the retail employee at the POS terminal 210, as shown at a block 342. Payment for the transaction may be accomplished using cash, credit, debit card, check, money order, etc.

Still referring to the flow chart 300 from FIG. 6B, the store server 36 may accumulate sales data related to the sale of goods for multiple transactions at the store 20 and transfer that data via the network 32 to the network computer 30, at a block 334. The transfer of the sales data may occur after each transaction, or it may occur periodically, such as hourly, nightly, weekly, monthly, etc. The network computer 30 may update the customer account database 102 with the latest sales data from the store 20. The retailer's network computer 30 may record the discounts from the transactions as account receivables at a block 346 and the network computer 30 may also periodically transfer sales data to third-party discounters 34 via the network 32 or any other acceptable link, for appropriate payment of the discounts.

Since the network computer 30 may be used to store the sales data from the stores 20, the retailer may further use the network computer 30 to manage a dividend award program. Alternatively, the retailer may utilize a separate dividend manager 50, as shown in FIG. 2, to manage the dividend award program. If a separate dividend manager 50 is used by the retailer, the retailer may transfer sales data from either the store(s) 20 or the network computer 30 to the dividend manager 50 via the network 32. Regardless of which arrangement the retailer uses, the customer's dividend account balance may be incremented based on the net value of the transaction at a block 350. For example, the retailer may offer a 10 percent dividend on the net value of the transaction, which is the amount of the transaction after the discounts from the third-party discounters have been taken into account.

If a separate dividend manager 50 is utilized by the retailer, then the updated dividend account balance for the customer may be transferred via the network 32 to the network computer's customer account database 102. The customer's updated dividend balance may also be transferred via the network 32 to the store server 36 and then to the customers ID card at a block 352, if the customer's ID card includes a data storage means as described above.

The retailer may provide the customer access to his/her current dividend balance through any retail store 20, through a system operatively connected to a toll-free telephone number, or through electronic access to the retailers web-site via the internet. As discussed above the customer may gain access to the retailer's website via the Internet and a client devise 80 as shown in FIG. 3. Once the customer's dividend account balance is updated, the customer may purchase goods from the retailer using the dividends previously awarded.

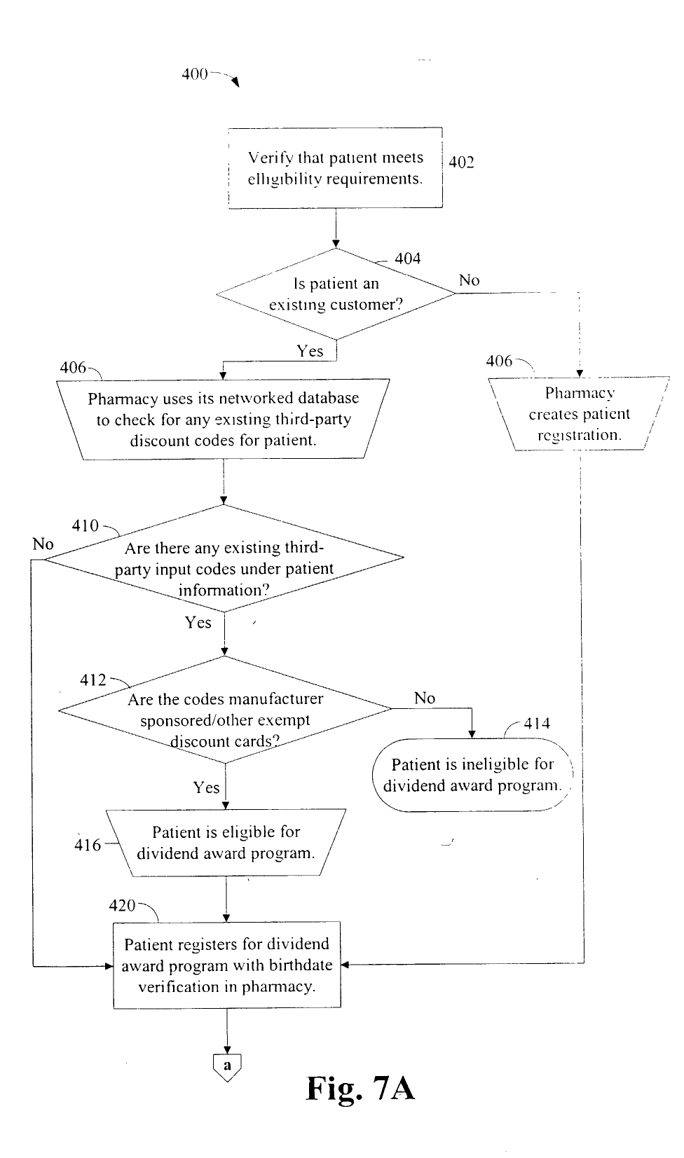

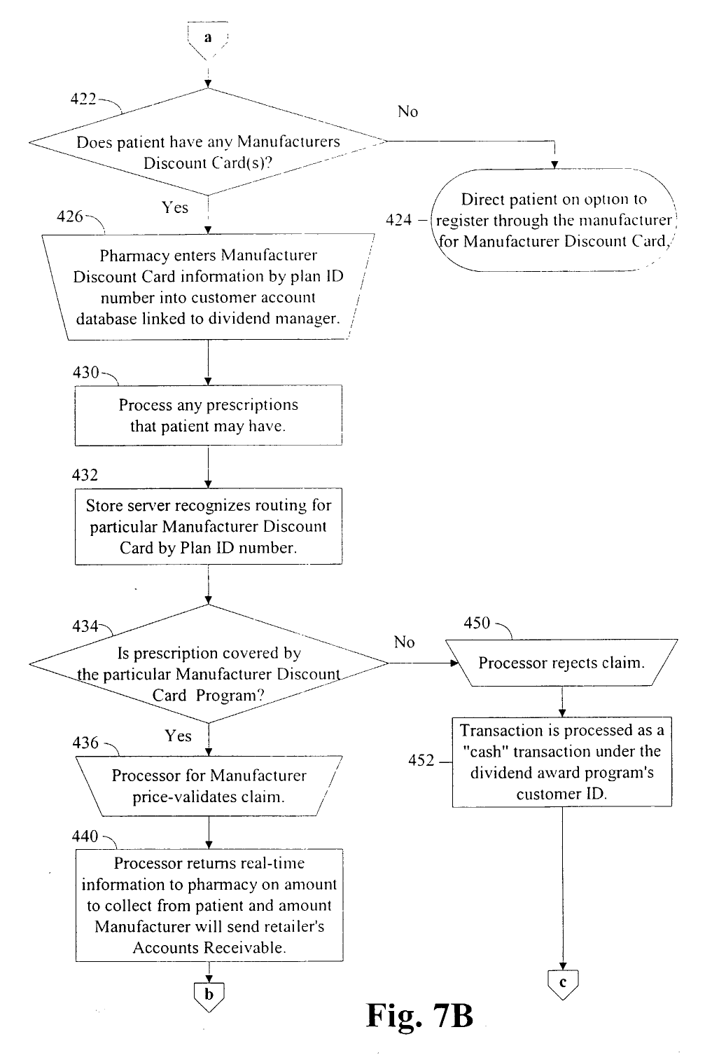

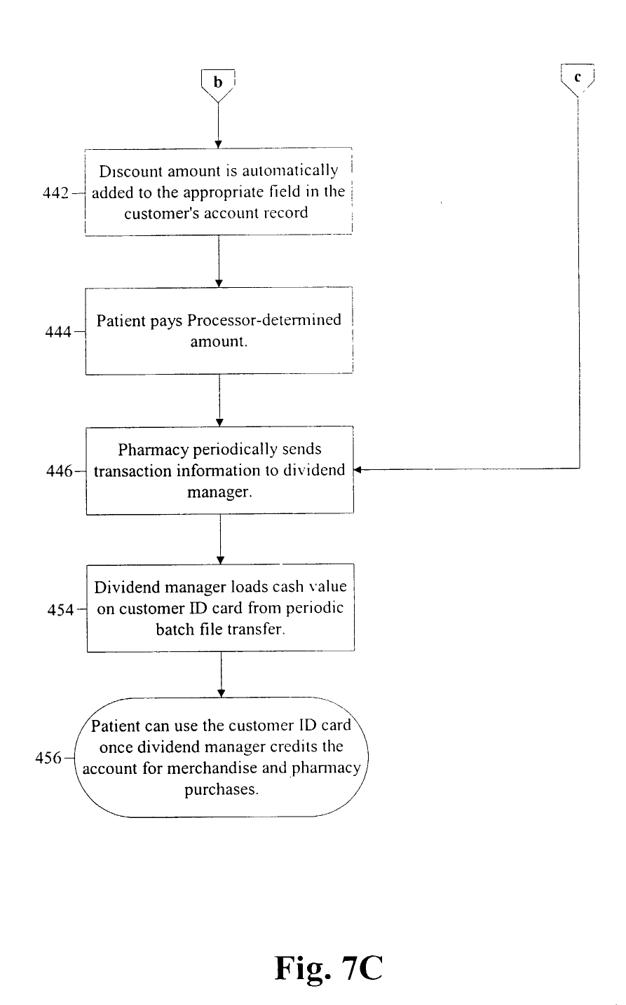

FIGS. 7A, 7B, and 7C are three parts of a flowchart 400 that describe an embodiment of a method to verify discounts from drug manufacturers and manage a dividend reward program in accordance with an aspect of the invention. While the flowchart 300 from FIGS. 6A and 6B is directed to a relatively generic example, the flowchart 400 is directed to a more specific embodiment that is related to a retail pharmacy system. As used herein, the term “pharmacy” is intended to encompass a single pharmacy as well as a plurality of pharmacies that are networked together in a manner similar to the stores 20 shown in FIGS. 1-3.

Referring to FIG. 7A, the flowchart may begin at a step 402 where a pharmacy employee verifies that a patient meets certain eligibility requirements. For example, the employee may check to see if the patient is cash paying, without insurance coverage, and over a certain age. If the patient meets the pharmacy's eligibility requirements, a check may be performed at a block 404 to determine if the patient is an existing pharmacy customer.

If the customer is not an existing pharmacy customer, the pharmacy may create an electronic patient registration record at a block 406. If it is determined at the block 404 that the patient is an existing pharmacy customer, the pharmacy may use its networked database to check for any existing third-party input codes for the patient at a block 406. The third-party input codes may be fields linked to the patient's account record that may be stored in the networked database described above and transmitted to the pharmacy's store server for temporary storage. The check for any existing third-party input codes stored under the patient's information may be performed at a block 410.

If it is determined at the block 410 that third-party input codes exist for the patient, a check may be made at a block 412 to determine if the codes are manufacturer sponsored discount cards or other exempt discount cards. If one or more third-party codes are present, and they are not manufacturer sponsored or otherwise exempt, the patient may be ineligible for the dividend award program. This is shown at a block 414. A reason the patient may be ineligible for the dividend award program is that the third-party codes may represent an insurer, which would disqualify the patient under the pharmacy's eligibility requirements.

After determining at the block 412 that the third-party codes are manufacturer sponsored or otherwise exempt, it may be determined that the patient is eligible for the dividend award program, as shown at a block 416. The patient may then register at a block 420 for the dividend award program with a birthdate verification in the pharmacy. Registering for the dividend award program may also be the next step in the flowchart after the pharmacy creates a patient registration at the block 406. Similarly, after determining at the block 410 that no third-party input codes exist for the patient, the patient may be registered for the dividend award program at the block 420.

FIG. 7B is the second page of the flowchart 400 and begins at a block 422 which may check to see if the patient has any Manufacturers Discount Cards. It should be noted that the Manufacturers Discount Cards may also be referred to as third-party discount cards and that Manufacturers may be referred to as third-party discounters. If the patient does not have any Manufacturers Discount Cards, the patient may be informed about the option to register through the manufacturer for a Manufacturer Discount Card, at a block 424.

After determining at the block 422 that the patient has a Manufacturers Discount Card, the pharmacy may enter, at a block 424, the Manufacturers Discount Card information by the customer's plan ID number into the pharmacy's patient account database which may be linked to a dividend manager. Thereafter, the pharmacy may process any prescriptions that the patient may have at a block 430.

Once the prescriptions have been entered into the pharmacy's POS terminal, the pharmacy's store server may recognize the appropriate routing for the particular Manufacturers Discount Card by Plan ID code, which can be an alphanumeric code, as shown at a block 432. Still referring to FIG. 7B, a check may then be made to determine if the prescription is covered by the particular Manufacturers Discount Card program, at a block 434.

If the prescription is covered by the particular Manufacturers Discount Card program, the processor for the manufacturer may price-validate the claim at a block 436. In price-validating the claim, the manufacturer may provide real-time information to the pharmacy on the amount to collect from the patient and the amount the manufacturer will send the pharmacy's Accounts Receivable. This is shown at a block 440.

FIG. 7C is the third page of the flowchart 400 and begins with a block 442, where the manufacturer's discount amount may be automatically added to the appropriate field in the patient's account record. At a block 444, the patient may pay the processor-determined amount for the prescription(s) in the transaction. The pharmacy may periodically send the transaction information to a dividend manager at a block 446. The dividend manager may be part of the pharmacy's data network, or it may be a separate organization that manages the dividend award program for the pharmacy.

Referring back to the block 434 from FIG. 7B, if it is determined that the prescription in the transaction is not covered by the particular Manufacturer Discount Card Program, the processor may reject the claim at a block 450 and the transaction may be processed at a block 452 as a “cash” transaction under the dividend award program's customer ID. The flowchart may then continue with the step of sending the transaction information to the dividend manager at the block 446.

After the transaction information is sent to the dividend manager, the dividend manager, at a block 454, may credit the appropriate cash value to the customer's account or load the cash value of the discounted transaction onto the customer's ID card from a periodic batch file transfer. The patient may use the customer ID card, once the dividend manager credits the customer's account, for merchandise and pharmacy purchases, as shown at a block 456.

Although the technique for providing third-party discounts and awarding dividends based on a net transaction amount, as described herein, is preferably implemented in software, it may be implemented in hardware, firmware, etc., and may be implemented by any other processor associated with the store and other facilities. Thus, the routine(s) described herein may be implemented in a standard multi-purpose CPU or on specifically designed hardware or firmware as desired. When implemented in software, the software routine(s) may be stored in any computer readable memory such as on a magnetic disk, a laser disk, or other storage medium, in a RAM or ROM of a computer or processor, etc. Likewise, the software may be delivered to a user or process control system via any known or desired delivery method including, for example, on a computer readable disk or other transportable computer storage mechanism or over a communication channel such as a telephone line, the Internet, etc. (which are viewed as being the same as or interchangeable with providing such software via transportable storage medium).

The invention has been described in terms of several preferred embodiments. It will be appreciated that the invention may otherwise be embodied without departing from the fair scope of the invention defined by the following claims.

We claim:

1. A method of linking a plurality of third-party discounters to a unique customer ID in a retail sales transaction comprising:
assigning a unique customer ID to a customer;
creating a customer account record associated with the unique customer ID;
adding a plurality of registered third-party discounters to the customer account record;
processing a sale of a good in a sales transaction;
identifying a registered third-party discounter associated with the good;
verifying that the customer is currently registered with the registered third-party discounter associated with the good to ensure a current eligibility of the customer;
applying a predetermined third-party discount to a gross sales price of the good to determine a net sales price for the good; and
collecting a monetary value from the customer equaling the net sales price for the good.

2. The method of claim 1, further comprising incrementing a dividend account balance associated with the customer account record.

3. The method of claim 2, wherein incrementing the dividend account balance comprises incrementing the dividend account balance based on the net sales price of the good.

4. The method of claim 2, further comprising storing the dividend account balance on a dividend card that is associated with the uniqued customer ID.

5. The method of claim 2, further comprising sending the customer a check equaling the value of the dividend account balance.

6. The method of claim 2, further comprising storing the dividend account balance in a central database.

7. The method of claim 2, further comprising allowing the customer to use a plurality of dividends in the dividend account balance to pay for a good.

8. The method of claim 1, further comprising verifying that the customer is eligible to receive discounts from the third-party discounters.

9. The method of claim 1, wherein verifying that the customer is currently registered with the registered third-party discounter is performed in real time.

10. The method of claim 1, further comprising checking to see if the customer wants to add a new registered third-party discounter to the customer account record.

11. The method of claim 1, further comprising applying an additional discount to the good in the sales transaction.

12. The method of claim 1, wherein applying the predetermined third-party discount comprises applying a rebate for the good.

13. The method of claim 1, wherein verifying that the customer is currently registered comprises sending a verification request to the third-party discounter.

14. The method of claim 13, wherein verifying that the customer is currently registered further comprises receiving a verification response from the third-party discounter.

15. The method of claim 1, wherein verifying that the customer is currently registered comprises conducting a real-time search of a database.

16. A method of linking a third-party discounter to a unique customer ID in a retail sales transaction comprising:
assigning a unique customer ID to a customer;
creating a customer account record associated with the unique customer ID;
adding a registered third-party discounter to the customer account record;
processing a sale of a good in a sales transaction;
determining if the registered third-party discounter offers a discount on the good;
verifying that the customer is currently registered with the registered third-party discounter associated with the good to ensure a current eligibility of the customer;
applying a predetermined third-party discount to a gross sales price of the good to determine a net sales price for the good;
collecting a monetary value from the customer equaling the net sales price for the good; and
incrementing a dividend account balance associated with the customer account record based on the net sales price.

17. The method of claim 16, wherein incrementing the dividend account balance comprises incrementing the dividend account balance based on the net sales price of the good.

18. The method of claim 16, further comprising storing the dividend account balance on a dividend card that is associated with the uniqued customer ID.

19. The method of claim 16, further comprising sending the customer a check equaling the value of the dividend account balance.

20. The method of claim 16, further comprising storing the dividend account balance in a central database.

21. The method of claim 16, further comprising allowing the customer to use a plurality of dividends in the dividend account balance to pay for a good.

22. The method of claim 16, further comprising verifying that the customer is eligible to receive the discount from the third-party discounter.

23. The method of claim 16, wherein verifying that the customer is currently registered with the registered third-party discounter is performed in real time.

24. The method of claim 16; further comprising checking to see if the customer wants to add a new registered third-party discounter to the customer account record.

25. The method of claim 16, further comprising applying an additional discount to the good in the sales transaction.

26. The method of claim 16, wherein applying the predetermined third -party discount comprises applying-a rebate for the good.

27. The method of claim 16, wherein verifying that the customer is currently registered comprises sending a verification request to the third-party discounter.

28. The method of claim 27, wherein verifying that the customer is currently registered further comprises receiving a verification response from the third-party discounter.

29. The method of claim 16, wherein verifying that the customer is currently registered comprises conducting a real-time search of a database.

30. A method of linking a plurality of drug manufacturers to a unique customer ID in a retail sales transaction comprising:
assigning a unique customer ID to a customer;
creating a customer account record associated with the unique customer ID;
adding a plurality of registered drug manufacturers to the customer account record;
processing a sale of a drug in a sales transaction;
identifying a registered drug manufacturer associated with the drug;
verifying that the customer is currently registered with the registered drug manufacturer associated with the drug to ensure a current eligibility of the customer;
applying a predetermined drug manufacturer discount to a gross sales price of the drug to determine a net sales price for the drug; and
collecting a monetary value from the customer equaling the net sales price for the drug.

31. The method of claim 30, further comprising incrementing a dividend account balance associated with the customer account record.

32. The method of claim 31, wherein incrementing the dividend account balance comprises incrementing the dividend account balance based on the net sales price of the drug.

33. The method of claim 31, further comprising storing the dividend account balance on a dividend card that is associated with the uniqued customer ID.

34. The method of claim 31, further comprising allowing the customer to use a plurality of dividends in the dividend account balance to pay for a good.

35. The method of claim 30, further comprising verifying that the customer is eligible to receive discounts from the drug manufacturer.

36. The method of claim 30, wherein verifying that the customer is currently registered with the registered drug manufacturer is performed in real time.

37. The method of claim 30, wherein applying the predetermined drug manufacturer discount comprises applying a rebate for the drug.

38. The method of claim 30, wherein verifying that the customer is currently registered comprises sending a verification request to the drug manufacturer.

39. The method of claim 30, wherein verifying that the customer is currently registered comprises conducting a real-time search of a database.

40. A method of linking a drug manufacturer to a unique customer ID in a retail sales transaction, comprising the steps of:
assigning a unique customer ID to a customer;
creating a customer account record associated with the unique customer ID;
adding a registered drug manufacturer to the customer account record;
processing a sale of a drug in a sales transaction;
determining if the registered drug manufacturer offers a rebate on the drug in the sales transaction;
verifying that the customer is currently registered with the registered drug manufacturer associated with the drug in the sales transaction to ensure a current eligibility of the customer;
applying a predetermined drug manufacturer rebate to a gross sales price of the drug to determine a net sales price of the drug;
collecting a monetary value from the customer equaling the net sales price of the drug; and
incrementing a dividend account balance associated with the customer account record based on the net sales price of the drug.

41. The method of claim 40, wherein incrementing the dividend account balance comprises incrementing the dividend account balance based on the net sales price of the drug.

42. The method of claim 40, further comprising storing the dividend account balance on a dividend card that is associated with the uniqued customer ID.

43. The method of claim 40, further comprising allowing the customer to use a plurality of dividends in the dividend account balance to pay for a good.

44. The method of claim 40, further comprising verifying that the customer is eligible to receive the rebate from the drug manufacturer.

45. The method of claim 40, wherein verifying that the customer is currently registered with the registered drug manufacturer is performed in real time.

46. The method of claim 40, further comprising checking to see if the customer wants to add a new registered drug manufacturer to the customer account record.

47. The method of claim 40, wherein verifying that the customer is currently registered comprises sending a verification request to the drug manufacturer.

48. The method of claim 40, wherein verifying that the customer is currently registered comprises conducting a real-time search of a database.

49. A dividend management system for linking a third-party discounter to a unique customer ID in a retail sales transaction comprising:
a processor a memory coupled to the processor;
a first software routine stored in the memory and adapted to be executed on the processor to assign a unique customer ID to a customer;
a second software routine stored in the memory and adapted to be executed on the processor to create a customer account record associated with the unique customer ID;
a third software routine stored in the memory and adapted to be executed on the processor to add a registered third-party discounter to the customer record;
a fourth software routine stored in the memory and adapted to be executed on the processor to process a sale of a good in a sales transaction;
a fifth software routine stored in the memory and adapted to be executed on the processor to determine if the registered third-party discounter offers a discount on the good;
a sixth software routine stored in the memory and adapted to be executed on the processor to verify that the customer is currently registered with the registered third-party discounter associated with the good to ensure a current eligibility of the customer;
a seventh software routine stored in the memory and adapted to be executed on the processor to apply a predetermined third-party discount to a gross sales price of the good to determine a net sales price for the good; and
an eighth software routine stored in the memory and adapted to be executed on the processor to increment a dividend account balance associated with the customer account record based on the net sales price.

50. The system of claim 49, wherein the system further comprises a ninth software routine stored in the memory and adapted to be executed on the processor to increment the dividend account balance based on the net sales price of the good.

51. The system of claim 49, wherein the system further comprises a ninth software routine stored in the memory and adapted to be executed on the processor to store the dividend account balance on a dividend card that is associated with the uniqued customer ID.

52. The system of claim 49, wherein the system further comprises a ninth software routine stored in the memory and adapted to be executed on the processor to allow the customer to use a plurality of dividends in the dividend account balance to pay for a good.

53. The system of claim 49, wherein the system further comprises a ninth software routine stored in the memory and adapted to be executed on the processor to verify that the customer is eligible to receive discounts from the third-party discounter.

54. The system of claim 49, wherein the sixth software routine stored in the memory and adapted to be executed on the processor to verify that the customer is currently registered with the registered drug manufacturer is performed in real time.

55. The system of claim 49, wherein the seventh software routine stored in the memory and adapted to be executed on the processor to apply the predetermined third-party discount comprises applying a rebate for the good.

56. The system of claim 49, wherein the sixth software routine stored in the memory and adapted to be executed on the processor to verify that the customer is currently registered comprises sending a verification request to the drug manufacturer.

57. The system of claim 49, wherein the sixth software routine stored in the memory and adapted to be executed on the processor to verify that the customer is currently registered comprises conducting a real-time search of a database.
